(19) United States
(12) Patent Application Publication
(10) Pub. No.: US 2016/0223141 A1
(43) Pub. Date: Aug. 4, 2016

(54) ASSEMBLY COMPRISING A PROTECTIVE CASING AND A GAS CYLINDER WITH A DEVICE FOR INDICATING PRESSURE OR AUTONOMY IN THE UP POSITION

(71) Applicant: L'Air Liquide, Société Anonyme pour I'Etude et l'Exploitation des Procédés Georges Claude, Paris (FR)

(72) Inventors: Emmanuel BAUNE, Saint Prix (FR); Damien GERMANI, Paris (FR); Renaud LIGONESCHE, Herblay (FR); Philippe RUDNIANYN, Villiers sur Orge (FR); Chiara TARANTELLO, Puteaux (FR)

(21) Appl. No.: 15/021,506

(22) PCT Filed: Mar. 12, 2014
(86) PCT No.: PCT/FR2014/050558

§ 371 Date: Mar. 11, 2016

(30) Foreign Application Priority Data
Sep. 12, 2013 (FR) 1358766
Sep. 16, 2013 (FR) 1358872

(51) Int. Cl. F17C 13/02; F17C 1/00; F17C 13/00

(52) U.S. Cl. CPC F17C 13/025; F17C 13/002; F17C 1/00; F17C 2201/0104; F17C 2201/032; F17C 2201/058; F17C 2203/0639; F17C 2203/0646; F17C 2203/0658; F17C 2205/0165; F17C 2205/0308; F17C 2205/0329; F17C 2205/0338; F17C 2205/0394; F17C 2221/011; F17C 2221/031; F17C 2221/03; F17C 2223/0123; F17C 2223/036; F17C 2250/043; F17C 2250/0491; F17C 2270/02

(57) ABSTRACT

The invention relates to a gas distribution assembly comprising a gas cylinder (2), a valve unit (12) fixed to the gas cylinder (2) and a protective cap (1) arranged around the said valve unit (12), the said valve unit (12) comprising an indicator device (4) indicating the pressure, such as a pressure gauge, or the content of the cylinder, such as an autonomy-indicating device, and a rotary handwheel (6), that can be turned by an operator, controlling the flow rate of gas, characterized in that the protective cap (1) comprises a first opening (11) formed in the region of the upper part (1a) of the protective cap (1) and within which the indicator device (4) indicating the pressure or content of the cylinder can be housed. Use of such an assembly for storing or distributing a gas or gas mixture, particularly a gas or gas mixture chosen from oxygen, air, N₂O/O₂, He/O₂ and NO/nitrogen.

### CROSS REFERENCE TO RELATED APPLICATIONS

This application is a 371 of International PCT Application PCT/FR2014/050558 filed Mar. 12, 2014 which claims priority to French Patent Application No. 1358766, filed Sep. 12, 2013, and French Patent Application No. 1358872, filed Sep. 16, 2013, the entire contents of which are incorporated herein by reference.

### BACKGROUND

The invention relates to an assembly for distributing gas, notably medical gas, comprising a gas cylinder, a valve unit fixed to the gas cylinder and a protective cap arranged around the said valve unit, the said valve unit comprising a pressure-indicating device, such as a pressure gauge, or a device indicating the content of the cylinder, such as an autonomy-indicating device, housed in the upper part of the protective cap and preferably a handwheel on the front of the cap.

Industrial and medical gases are commonly packaged in gas containers, typically gas cylinders, fitted with a valve unit, with or without an in-built pressure regulator, namely a simple valve of the open/closed type or a valve with an in-built pressure regulator also referred to as a pressure-regulating valve or regulator, allowing control over the flow rate and pressure of the gas delivered. In order to protect this valve unit it is common practice to arrange in the region of the neck of the gas cylinder and around the said valve unit a protective cap that forms a protective shell around the said valve unit. Such a cap is commonly referred to as a “bonnet”.

Moreover, to allow the cylinder/bonnet/valve assembly to be attached to a support such as a rung of a hospital bed, a stretcher, a bar or an attachment support in an emergency vehicle, for example an emergency ambulance or the like, it is commonplace for a fixed or mobile, notably pivoting, attachment system to be formed on the bonnet.

To make the cylinder/valve unit/cap assembly easier to transport and to handle it is commonplace to provide the cap with a carry handle which, in general, surmounts it and allows users to carry it with one hand.

Caps of this type are notably described in documents EP-A-629812, DEA-10057469, US-A-2004/020793 and EP-A-2586481.

In order to control the pressure of the gas it is common practice to fix a pressure-indicating device such as a pressure gauge on one of the passages for gas passing through the valve unit.

Now, positioning this pressure-indicating device towards the bottom of the valve, because of technical constraints, notably because the gas passage subjected to the pressure of the cylinder is situated towards the bottom part of the valve, means that it is often difficult or not very easy to read the pressure indicated by the pressure-indicating device and this pressure is often misread.

Furthermore, in order to control the flow rate of the gas delivered, i.e. to allow or prevent the passage of gas through the valve unit and therefore allow or prevent the emergence of gas from the said unit, a rotary handwheel that acts on control members internal to the valve unit is often arranged on the valve unit. Now, once again, because of the use of a protective cap surrounding the valve unit, it is often difficult or not very easy for the user to turn the rotary handwheel.

In the light of that, the problem that arises is that of making the pressure-indicating device with which a valve unit protected by a protective cap for a gas cylinder is equipped more comfortable to read while at the same time avoiding the abovementioned disadvantages and furthermore preferably allowing the rotary handwheel that controls the flow rate of gas to be turned with ease.

### SUMMARY

The solution of the invention is a gas distribution assembly comprising a gas cylinder, a valve unit fixed to the gas cylinder and a protective cap arranged around the said valve unit the said valve unit comprising an indicator device indicating the pressure, such as a pressure gauge, or the content of the cylinder, and a rotary handwheel, that can be turned by an operator, controlling the flow rate of gas, characterized in that the protective cap comprises a first opening formed in the region of the upper part of the protective cap and within which the indicator device indicating the pressure or content of the cylinder can be housed.

Depending on circumstance, the assembly of the invention may comprise one or more of the following technical features:
the pressure-indicating device is a pressure gauge.
the indicator device indicating the content of the cylinder is an indicator of autonomy in terms of gas.
the device indicating the content of the cylinder is a dial-type or digital device indicating an estimate of the duration of use of the gas corresponding to the remaining quantity of gas in the cylinder.
the device indicating the content of the cylinder is preferably an electronic device which calculates and displays an autonomy in gas expressed in units of time.
the indicator device indicating the pressure or content of the cylinder is fixed to the valve unit in such a way as to be able to measure the gas pressure obtaining within a gas passage passing through the said valve unit.
the protective cap comprises a second opening formed laterally in the protective cap and in which the rotary handwheel can be housed.
the axis (AA) of the pressure gauge or of the content indicator, the axis (BB) of the rotary handwheel and the axis (CC) of the cylinder are coplanar.
the axis (AA) of the pressure gauge or of the content indicator and the axis (BB) of the rotary handwheel make an angle (a) of between 0° and 90°, preferably between 30° and 85°.
the protective cap comprises a planar surface in the region of its upper part, the first opening being formed in the said planar surface.
the indicator device indicating the pressure or content of the cylinder is arranged in the first opening formed in the planar surface so as to lie flush with the said planar surface.
alternatively, the indicator device indicating the pressure or content of the cylinder is arranged in the first opening formed in the planar surface so as to be set back slightly within the housing formed by the first opening with respect to the said planar surface, preferably set back by 0.1 to 10 mm.
alternatively again, the indicator device indicating the pressure or content of the cylinder is arranged in the first opening formed in the planar surface so as to project from the housing formed by the first opening with respect to the said planar surface, preferably projecting by 0.1 to 10 mm.
the planar surface forms a face that is oblique with respect to the axis of the cylinder.
the valve unit is a regulating valve.
the pressure-indicating device is a dial-type pressure gauge or an electronic pressure gauge.
the cap is made of polymer, preferably plastic. the protective cap further comprises a carry handle connected to the cap by one or more support uprights.
the protective cap is arranged on the protective cap so that the pressure-indicating or autonomy-indicating device is positioned between the carry handle and the valve unit bearing said pressure-indicating device.
the valve unit further comprises a gas outlet connector and a filling connector.
the rotary handwheel is arranged on the front face of the cap.
the cap is made of a polymer material or of a metal or metal alloy, preferably made of plastic such as PVC, PE, PET, PP, PMMA, PU, PA, etc. It should be noted that the plastic may be filled or reinforced, i.e. contain added fibres for example.
the carry handle and/or the support uprights are made of a rigid material chosen from polymers and metals or metal alloys.
the carry handle is generally longiform. Its length is typically comprised between 5 and 20 cm, preferably between 6 and 15 cm.
the carry handle surmounts the cap body.
the carry handle is horizontal or near-horizontal and is perpendicular to the axis of the cap.
the gas cylinder has a size of between 10 and 150 cm.
the gas cylinder contains from 0.5 to 20 litres (water equivalent capacity).
the gas cylinder has a hollow cylindrical body.
the gas cylinder has a neck bearing a gas outlet orifice to which the valve unit is fixed.
the gas cylinder contains a gas or gas mixture chosen from oxygen, air, an N₂O/O₂ mixture, an He/O₂ mixture, an NO/nitrogen mixture or any other gas or gas mixture.
the cylinder is made of steel, of an aluminium alloy or of a composite material or combination of several of these materials.
the cylinder contains a gas at a pressure of up to 350 bar approximately.

The invention also relates to a use of a gas distribution assembly according to the invention for storing or distributing a gas or gas mixture, preferably a medical gas or gas mixture. For preference, the gas or gas mixture is chosen from oxygen, air, N₂O/O₂, He/O₂, NO/nitrogen.

### BRIEF DESCRIPTION OF THE DRAWINGS

The invention will now be better understood through the detailed description that follows, given by way of nonlimiting illustration with reference to the attached figures among which:

FIG. 1 depicts one embodiment of a cylinder/valve unit/cap assembly according to the invention,

FIG. 2 depicts a view of the front face of the cap of FIG. 1 and

FIG. 3 depicts a side view of the cap of FIG. 1.

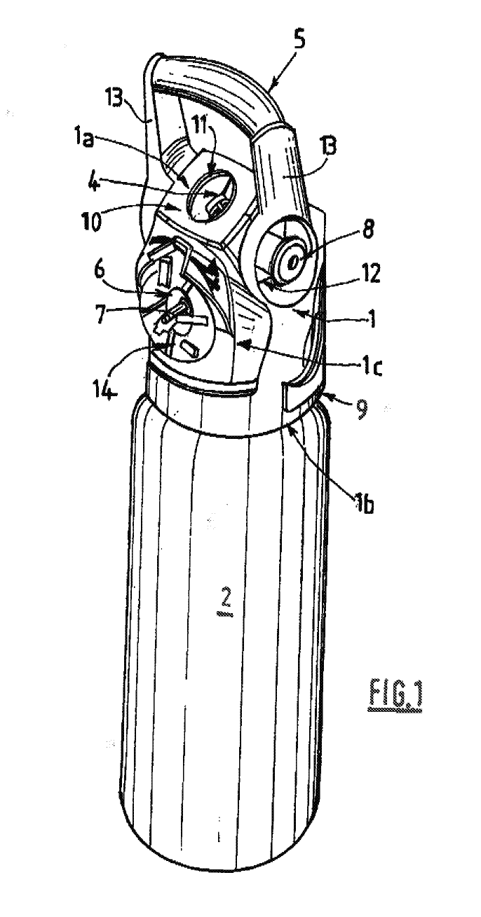

FIG. 1 depicts one embodiment of a rigid protective cap 1 commonly referred to as a “bonnet” arranged around a valve unit 12 (not fully visible), namely a valve with or without an in-built pressure regulator, itself fixed to the neck of a gas cylinder 2, the said protective cap 1 being provided with a carry handle 5 according to the present invention.

### DESCRIPTION OF PREFERRED EMBODIMENTS

The gas cylinder 2 typically has a cylindrical body made of steel and a size of between 10 and 150 cm, with a capacity of 0.5 to 20 litres (water equivalent).

The protective cap 1 protects the valve unit against knocks whether the valve unit 12 be of the type with in-built pressure regulator, or regulating valve type, or of the type without an in-built regulator, typically a valve of the regulating valve type. The fixing around the valve unit 12 onto the neck of the gas cylinder 2 is by screwing.

More specifically, the protective cap 1 comprises a cap body forming a protective shell around an internal volume dimensioned to house the valve unit 12, and a carry handle 5 which is designed to be held by a user in one hand.

The carry handle 5 surmounts the protective cap 1.

The carry handle 5 is made of a rigid material, such as a polymer or a metal or metal alloy, and is borne by one or more support uprights 13 mechanically connecting the cap body to the carry handle 5. The carry handle 5 is generally arranged horizontally, namely perpendicular or near-perpendicular to the vertical axis of the cylinder 2 and of the cap 1. The carry handle 5 has a longilinear shape, whether straight or curved, typically a length less than 20 cm, typically of 6 to 15 cm.

The support upright or uprights 13 are fixed to one or both ends of the carry handle 5 so as to allow a user to easily carry the bonnet/valve/cylinder assembly around using the said carry handle 5.

The cap body 1 is typically made of a material of the polymer and/or metal type, preferably a plastic such as PVC, PE, PET, PP, PMMA, PU, PA, etc.

Likewise, the support uprights 13 may be made of a plastic, like the body of the cap 1, but may equally be made of an aluminium alloy or any other metallic material. They may be fixed to the handle 5 by screwing or welding, for example, or formed as one piece.

The protective cap 1 also has openings 11, 14 providing access to the valve unit 12 situated inside the internal volume of the cap body 1.

More specifically, a first opening 11 is formed at the upper part 1a, also referred to as the top, of the protective cap 1, in which opening will be housed an indicator device indicating the pressure, such as a pressure gauge 4, either of the dial type or of the electronic type, or the content of the cylinder, such as an autonomy-indicating device. The lower part 1b, also referred to as the bottom, of the cap 1 is situated at the level of the cylinder 2.

For the sake of simplicity, in the remainder of the description, it is a pressure-indicating device that will be discussed, but the explanations given apply stricto sensu to an indicator device indicating the content of the cylinder, such as an autonomy indicating device, which would be substituted for the pressure-indicating device.

Moreover, the protective cap 1 comprises a second opening 14 formed on the front of the protective cap 1, in which opening the rotary handwheel 6 controlling the flow of gas passing through the valve unit 12 is housed.

More specifically, the valve unit 12 comprises a rotary handwheel 6, situated on the front face, that a user can turn in order to control the flow of gas, which rotary handwheel 6 is arranged around a gas outlet connector 7 in order to draw off gas stored in the cylinder 2.

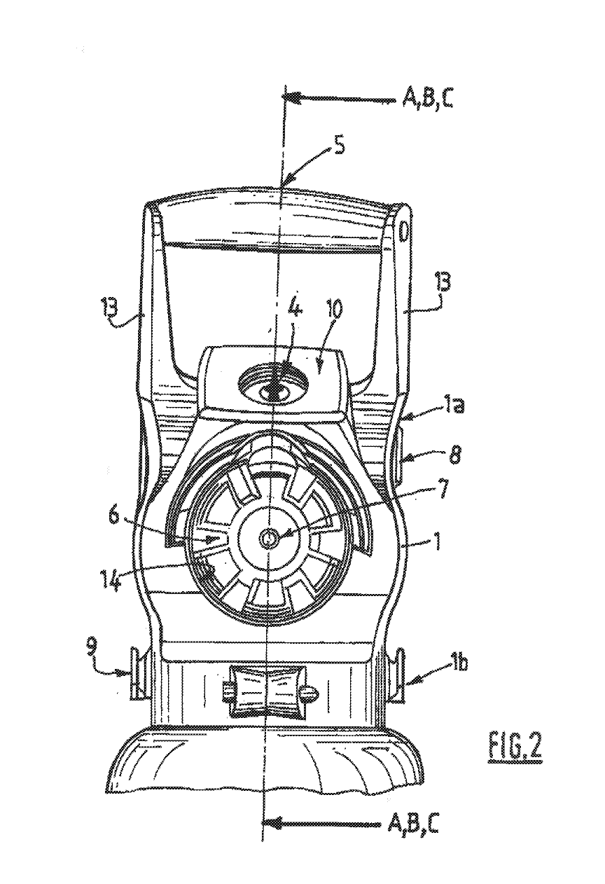

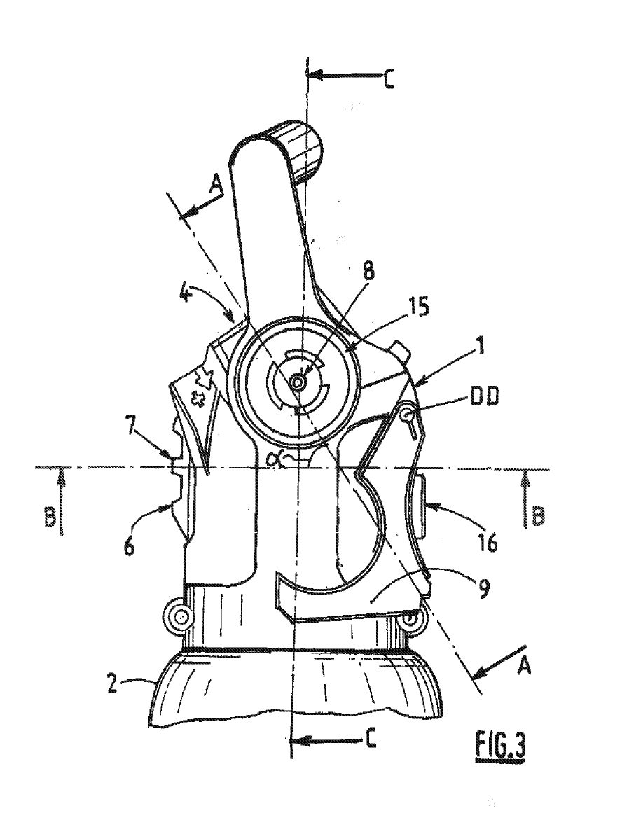

For preference, the axis AA of the pressure-indicating device, namely of the pressure gauge 4, the axis BB of the rotary handwheel 6, and the axis CC of the cylinder 2 are coplanar. Advantageously, the axis AA of the pressure-indicating device 4 and the axis BB of the rotary handwheel 6 make an angle α of between 0° and 90°, preferably of at least 30°, for example of between 45° and 85°, as illustrated in FIGS. 2 and 3.

According to the embodiment depicted schematically in FIGS. 1 to 3, the protective cap 1 comprises a planar surface 10 in its upper part 1a, namely at the top of the cap 1, within which planar surface 10 the first opening 11 is formed. The planar surface 10 in fact constitutes a face that is oblique with respect to the axis of the cylinder 2. For preference, the planar surface 10 is perpendicular to the axis AA of the pressure gauge 4, as indicated schematically in FIG. 3.

According to the embodiment considered, the pressure-indicating device 4 is arranged in the first opening 11 formed in the planar surface 10 in such a way that its window at the top lies flush with the said planar surface 10 or is set back slightly into the housing formed by the first opening 11 with respect to the said planar surface 10 or, alternatively still, and conversely, projects slightly outwards from the planar surface 10.

The pressure-indicating device 4 may be fixed to the body of the valve unit situated inside the internal volume of the cap 1 or to the cap.

Such an arrangement of the pressure-indicating device 4, i.e. of the pressure gauge, at the top on the front of the cap 1, preferably with the viewing window inclined to form a given angle with respect to the axis CC of the cylinder 2, makes it considerably easier for the user to read off the pressure delivered by the pressure-indicating device or pressure gauge 4, whether this be a dial-type or an electronic gauge.

Furthermore, positioning the rotary handwheel that the user can turn on the façade 1c of the cap 1 makes it easier to turn the rotary handwheel that controls the flow of gas.

Moreover, the valve unit 12 also comprises a filling connector 16 (cf. FIG. 3) situated on the rear face and accessible via a third opening (not visible in the figures) formed in the rear face of the cap 1, which filling connection is used for introducing gas into the cylinder 2 when the latter is empty or almost empty, and an outlet connector for pressurized gas 8, which is arranged on the lateral face of the cap (see FIG. 3) within a fourth opening 15 made in the body of the cap 1.

In order to allow the cylinder/valve unit/cap assembly to be attached or fastened to a support, such as a rung of a hospital bed, or stretcher, the protective cap 1 comprises, on the side of its rear face, an attachment device 9 that can pivot between a fully folded position referred to as the “rest” position (indicated schematically in FIG. 3), namely the position adopted by the attachment device 9 when stored and in contact or almost in contact with the body of the cap 1, and a fully unfolded position referred to as the “attachment” position, namely the position adopted by the attachment device 9 when it is fully deployed and can be attached to a support, such as a rung of a bed or the like. The attachment device 9 pivots through a given angle about the axis DD of pivoting shown in FIG. 3.

A gas cylinder 2 equipped with a cap 1 with pressure-indicating or autonomy-indicating device according to the invention is particularly well suited to use in a medical environment, and in particular is suited to the storage of any medical gas or gas mixture, particularly of the oxygen, air, N₂O/O₂, He/O₂, NO/nitrogen or other type

1. A gas distribution assembly comprising a gas cylinder (2), a valve unit (12) fixed to the gas cylinder (2) and a protective cap (1) arranged around the said valve unit (12), the said valve unit (12) comprising a pressure-indicating or autonomy-indicating device (4) and a rotary handwheel (6), that can be turned by an operator, controlling the flow rate of gas, characterized in that the protective cap (1) comprises a first opening (11) formed in the region of the upper part (1 a) of the protective cap (1) and within which the indicator device (4) indicating the pressure or content of the cylinder can be housed.

2. The assembly according to claim 1, characterized in that the protective cap (1) comprises a second opening (14) formed laterally in the protective cap (1) and in which the rotary handwheel (6) can be housed.

3. The assembly according to claim 1, characterized in that an axis (AA) of the indicator device (4) indicating the pressure or content of the cylinder, an axis (BB) of the rotary handwheel (6) and an axis (CC) of the cylinder (2) are coplanar.

4. The assembly according to claim 1, characterized in that an axis (AA) of the pressure gauge or of the device indicating the content of the cylinder and an axis (BB) of the rotary handwheel (6) make an angle (α) of between 0° and 90°.

5. The assembly according to claim 1, characterized in that the protective cap (1) comprises a planar surface (10) in the region of its upper part (1a), the first opening (11) being formed in the planar surface (10).

6. The assembly according to claim 5, characterized in that the indicator device (4) indicating the pressure or content of the cylinder is arranged in the first opening (11) formed in the planar surface (10) so as to lie flush with the said planar surface (10) or so as to be set back slightly within the housing formed by the first opening (11) with respect to the said planar surface (10).

7. The assembly according to claim 6, characterized in that the planar surface (10) forms a face that is oblique with respect to the axis of the cylinder (2).

8. The assembly according to claim 1, characterized in that the valve unit (12) is a pressure regulating valve.

9. The assembly according to claim 1, characterized in that the pressure-indicating device (4) is a dial pressure gauge or an electronic pressure gauge or the device indicating the content of the cylinder is an autonomy-indicating device.

10. The assembly according to claim 1, characterized in that the cap (1) is made of polymer.

11. The assembly according to claim 1, characterized in that the protective cap (1) further comprises a carry handle (5) connected to the cap (1) by one or more support uprights (13), and the carry handle (5) is arranged on the protective cap (1) so that the indicator device (4) is positioned between the carry handle (5) and the valve unit (12) bearing said indicator device (4).

12. The assembly according to claim 1, characterized in that the rotary handwheel (6) is arranged on the a front face (1c) of the cap (1).

13. The assembly according to claim 1, characterized in that the rotary handwheel (6) is arranged coaxially around a gas outlet connector (7), within a second opening (14).

14. The assembly according to claim 1, characterized in that the protective cap (1) further comprises an attachment device (9).

15. (canceled)
